(19) United States
(12) Patent Application Publication
(10) Pub. No.: US 2025/0112844 A1
(43) Pub. Date: Apr. 3, 2025

(54) SYSTEM AND METHOD FOR USER OPTIMIZED APPLICATION DEPENDENCY MAPPING

(71) Applicant: Cisco Technology, Inc., San Jose, CA (US)

(72) Inventors: Omid Madani, San Carlos, CA (US); Ali Parandehgheibi, Sunnyvale, CA (US); Navindra Yadav, Cupertino, CA (US); Vimalkumar Jeyakumar, Los Altos, CA (US); Ellen Christine Scheib, Mountain View, CA (US); Mohammadreza Alizadeh Attar, Cambridge, MA (US)

(21) Appl. No.: 18/980,374

(22) Filed: Dec. 13, 2024

Related U.S. Application Data
(63) Continuation of application No. 17/559,674, filed on Dec. 22, 2021, now Pat. No. 12,231,307.
Application No. 17/559,674 is a continuation of application No. 15/140,365, filed on Apr. 27, 2016, now Pat. No. 11,252,058.
(60) Provisional application No. 62/171,899, filed on Jun. 5, 2015.

(51) Int. Cl. H04L 43/045; G06F 3/0482; G06F 3/04842; G06F 3/04847; G06F 9/455; G06F 16/11; G06F 16/13; G06F 16/16; G06F 16/17; G06F 16/174; G06F 16/23; G06F 16/2457; G06F 16/248; G06F 16/28; G06F 16/29; G06F 16/9535; G06F 21/53; G06F 21/55; G06F 21/56; G06N 20/00; G06N 99/00; G06T 11/20; H04J 3/06; H04J 3/14; H04L 1/24; H04L 7/10; H04L 9/08; H04L 9/32; H04L 9/40; H04L 41/046; H04L 41/0668; H04L 41/0803; H04L 41/0806; H04L 41/0816; H04L 41/0893; H04L 41/12; H04L 41/16; H04L 41/22; H04L 43/02; H04L 43/026; H04L 43/04; H04L 43/062; H04L 43/08; H04L 43/0805; H04L 43/0811; H04L 43/0829; H04L 43/0852; H04L 43/0864; H04L 43/0876; H04L 43/0882; H04L 43/0888; H04L 43/10; H04L 43/106; H04L 43/12; H04L 43/16; H04L 45/00; H04L 45/302; H04L 45/50; H04L 45/74; H04L 47/11; H04L 47/20; H04L 47/2441; H04L 47/2483; H04L 47/28; H04L 47/31; H04L 47/32; H04L 61/5007; H04L 67/01; H04L 67/10; H04L 67/1001; H04L 67/12; H04L 67/50; H04L 67/51; H04L 67/75; H04L 69/16; H04L 69/22; H04W 72/54; H04W 84/18

(52) U.S. Cl. CPC H04L 43/045; G06F 3/0482; G06F 3/04842; G06F 3/04847; G06F 9/45558; G06F 16/122; G06F 16/137; G06F 16/162; G06F 16/17; G06F 16/173; G06F 16/174; G06F 16/1744; G06F 16/1748; G06F 16/2322; G06F 16/235; G06F 16/2365; G06F 16/24578; G06F 16/248; G06F 16/285; G06F 16/288; G06F 16/29; G06F 16/9535; G06F 21/53; G06F 21/552; G06F 21/556; G06F 21/566; G06N 20/00; G06N 99/00; G06T 11/206; H04J 3/0661; H04J 3/14; H04L 1/242; H04L 7/10; H04L 9/0866; H04L 9/3239; H04L 9/3242; H04L 41/046; H04L 41/0668; H04L 41/0803; H04L 41/0806; H04L 41/0816; H04L 41/0893; H04L 41/12; H04L 41/16; H04L 41/22; H04L 43/02; H04L 43/026; H04L 43/04; H04L 43/062; H04L 43/08; H04L 43/0805; H04L 43/0811; H04L 43/0829; H04L 43/0841; H04L 43/0858; H04L 43/0864; H04L 43/0876; H04L 43/0882; H04L 43/0888; H04L 43/10; H04L 43/106; H04L 43/12; H04L 43/16; H04L 45/306; H04L 45/38; H04L 45/46; H04L 45/507; H04L 45/66; H04L 45/74; H04L 47/11; H04L 47/20; H04L 47/2441; H04L 47/2483; H04L 47/28; H04L 47/31; H04L 47/32; H04L 61/5007; H04L 63/0227; H04L 63/0263; H04L 63/06; H04L 63/0876; H04L 63/1408; H04L 63/1416; H04L 63/1425; H04L 63/1433; H04L 63/1441; H04L 63/145; H04L 63/1458; H04L 63/1466; H04L 63/16; H04L 63/20; H04L 67/01; H04L 67/10; H04L 67/1001; H04L 67/12; H04L 67/51; H04L 67/75; H04L 69/16; H04L 69/22; H04W 72/54; H04W 84/18; G06F 2009/4557; G06F 2009/45587; G06F 2009/45591; G06F 2009/45595; G06F 2221/033; G06F 2221/2101; G06F 2221/2105; G06F 2221/2111; G06F 2221/2115; G06F 2221/2145; H04L 67/535

(57) ABSTRACT

This disclosure generally relates to a method and system for mapping application dependency information. The present technology relates techniques that enable user-adjustable application dependency mapping of a network system. By collecting internal network data using various sensors in conjunction with external user inputs, the present technology can provide optimized application dependency mapping using user inputs.

### CROSS-REFERENCE TO RELATED APPLICATIONS

This application is a continuation of U.S. Non-Provisional patent application Ser. No. 17/559,674, filed Dec. 22, 2021, which in turn is a continuation of U.S. Non-Provisional patent application Ser. No. 15/140,365, filed Apr. 27, 2016, now U.S. Pat. No. 11,252,058 issued Feb. 15, 2022, which claims the benefit of U.S. Provisional Patent Application No. 62/171,899, filed Jun. 5, 2015, the contents of which are incorporated herein by reference in their entireties.

### TECHNICAL FIELD

The disclosure relates generally to computer networks. More specifically, certain embodiments of the technology relate to a method and system for mapping application dependency information.

### BACKGROUND

Network infrastructure management is important for business and organizations. To track application dependencies, IT management has relied on conventional techniques such as spreadsheets. But the proliferation of virtualized data centers and cloud services has made it increasingly difficult to track dependencies using traditional methods.

For example, traditional IT management technologies are unable to map individual application and specifically unable to discover which computing component supports each application. As businesses have attempted to utilize IT management systems for more complex business and application management, they have discovered that this is a very manual process, involving constant maintenance and complex programming.

### BRIEF DESCRIPTION OF THE DRAWINGS

In order to describe the manner in which the above-recited and other advantages and features of the disclosure can be obtained, a more particular description of the principles briefly described above will be rendered by reference to specific examples thereof which are illustrated in the appended drawings. Understanding that these drawings depict only examples of the disclosure and are not therefore to be considered to be limiting of its scope, the principles herein are described and explained with additional specificity and detail through the use of the accompanying drawings in which:

FIG. 1 illustrates a schematic block diagram of an application dependency mapping system, according to some embodiments;

FIG. 2 illustrates an example of an application dependency mapping system adopting a leaf-spine architecture, according to some embodiments;

FIG. 3 illustrates an example of a user interface of an application dependency mapping system, according to some embodiments;

FIG. 4 illustrates another example of a user interface of an application dependency mapping system, according to some embodiments;

FIG. 5 is a flow diagram illustrating an example of a process for an application dependency mapping system, according to some embodiments; and

FIGS. 6A and 6B illustrate a computing platform of a computing device, according to some embodiments.

### DESCRIPTION OF EXAMPLE EMBODIMENTS

Various embodiments of the present technology are discussed in detail below. While specific implementations are discussed, it should be understood that this is done for illustration purposes only. A person skilled in the relevant art will recognize that other components and configurations may be used without departing from the spirit and scope of the present technology.

### Overview

Aspects of the present technology relate to techniques that enable user-adjustable application dependency mapping of a network system. By collecting internal network data using various sensors in conjunction with external user inputs, the present technology can provide user optimized application dependency mapping.

In accordance with one aspect of the present disclosure, a computer-implemented method is provided. The method includes receiving network data using a plurality of sensors associated with a plurality of nodes of a network, generating, based at least in part on the network data, a first application dependency map of an application executing in the network, the first dependency map representing an application network topology, receiving, via a user interface, an adjustment to an input parameter of the network, generating a second application dependency map of the application, the second dependency map representing an updated network topology, and displaying at least a portion of the second application dependency map.

According to some embodiments, the present technology can enable a system comprising: one or more processors, and memory including instructions that, upon being executed by the one or more processors, cause the system to receive network data using a plurality of sensors associated with a plurality of nodes of a network, the plurality of sensors including at least a first sensor of a physical switch, a second sensor of a hypervisor associated with the physical switch, and a third sensor of a virtual machine associated with the hypervisor, generate, based at least in part on the network data, a first clustering of the plurality of nodes, receive, via a user interface, an adjustment to an input parameter of the network, generate a second clustering of the plurality of nodes based at least in part on the adjustment, and display at least a portion of data related to the second clustering.

In accordance with another aspect of the present disclosure, a non-transitory computer-readable storage medium storing instructions is provided, the instructions which, when executed by a processor, cause the processor to perform operations including, receive network data using a plurality of sensors associated with a plurality of nodes of a network, generate, based at least in part on the network data, a first application dependency map of an application executing in the network, the first dependency map representing an application network topology, receive, via a user interface, an adjustment to an input parameter of the network, generate a second application dependency map of the application, the second dependency map representing an updated network topology, and display at least a portion of the second application dependency map.

Although many of the examples herein are described with reference to the application dependency mapping and discovery, it should be understood that these are only examples and the present technology is not limited in this regard. Rather, any other network information applications may be realized. Additionally, even though the present disclosure uses a sensor as a data-collecting device, the present technology is applicable to other controller or device that is capable of review, record and report network communication data between various end groups.

Additional features and advantages of the disclosure will be set forth in the description which follows, and, in part, will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### DETAILED DESCRIPTION

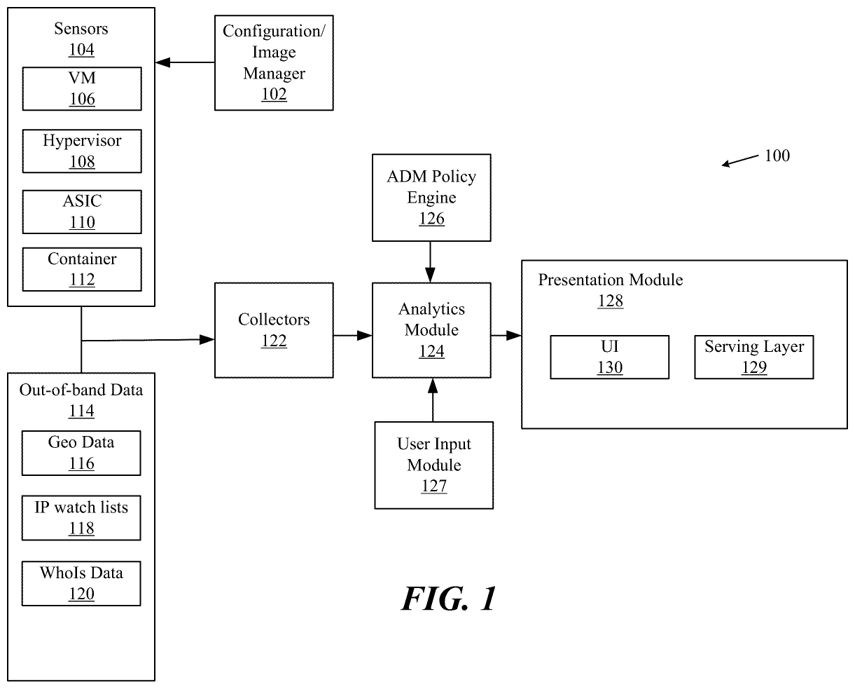

FIG. 1 illustrates a schematic block diagram of an application dependency mapping system 100, according to some embodiments. Application dependency mapping system 100 can include, for example, configuration/image imaginer 102, sensors 104, collectors 122, analytics module 124, ADM policy engine 126, user input module 127 and presentation module 128. It should be appreciated that the system topology in FIG. 1 is an example, and any numbers of computing devices such as sensors, collectors, and network components may be included in the system of FIG. 1.

Configuration/image manager 102 can configure and manage sensors 104. For example, when a new virtual machine is instantiated or when an existing virtual machine is migrated, configuration/image manager 102 can provision and configure a new sensor on the virtual machine. According to some embodiments, configuration/image manager 102 can monitor the physical status or heathy of sensors 104. For example, configuration/image manager 102 might request status updates or initiate tests. According to some embodiments, configuration/image manager 102 also manages and provisions virtual machines.

According to some embodiments, configuration/image manager 102 can verify and validate sensors 104. For example, sensors 104 can be provisioned with a unique ID that is generated using a one-way hash function of its basic input/output system (BIOS) universally unique identifier (UUID) and a secret key stored on configuration and image manager 102. This unique ID can be a large number that is difficult for an imposter sensor to guess. According to some embodiments, configuration/image manager 102 can keep sensors 104 up to date by installing new versions of their software and applying patches. Configuration/image manager 102 can get these updates from a local source or automatically from a remote source via internet.

Sensors 104 can be associated with each node and component of a data center (e.g., virtual machine, hypervisor, slice, blade, switch, router, gateway, etc.). Sensors 104 can monitor communications to and from the component, report on environmental data related to the component (e.g., component IDs, statuses, etc.), and perform actions related to the component (e.g., shut down a process, block ports, redirect traffic, etc.). Sensors 104 can send their records over a high-bandwidth connection to the collectors 122 for storage.

Sensors 104 can comprise software codes (e.g., running on virtual machine 106, container 112, or hypervisor 108), an application-specific integrated circuit (ASIC 110, e.g., a component of a switch, gateway, router, or standalone packet monitor), or an independent unit (e.g., a device connected to a switch's monitoring port or a device connected in series along a main trunk of a datacenter). For clarity and simplicity in this description, the term “component” is used to denote a component of the network (i.e., a process, module, slice, blade, hypervisor, machine, switch, router, gateway, etc.). It should be understood that various software and hardware configurations can be used as sensors 104. Sensors 104 can be lightweight, minimally impeding normal traffic and compute resources in a datacenter. Software sensors 104 can “sniff” packets being sent over its host network interface card (NIC) or individual processes can be configured to report traffic to sensors 104.

According to some embodiments, sensors 104 reside on every virtual machine, hypervisor, switch, etc. This layered sensor structure allows for granular packet statistics and data collection at each hop of data transmission. In some embodiments, sensors 104 are not installed in certain places. For example, in a shared hosting environment, customers may have exclusive control of VMs, thus preventing network administrators from installing a sensor on those client-specific VMs.

As sensors 104 capture communications, they can continuously send network flow data to collectors 122. The network flow data can relate to a packet, collection of packets, flow, group of flows, open ports, port knocks, etc. The network flow data can also include other details such as the VM bios ID, sensor ID, associated process ID, associated process name, process user name, sensor private key, geo-location of sensor, environmental details, etc. The network flow data can comprise data describing the communication on all layers of the OSI model. For example, the network flow data can include Ethernet signal strength, source/destination MAC address, source/destination IP address, protocol, port number, encryption data, requesting process, a sample packet, etc.

Sensors 104 can preprocess network flow data before sending. For example, sensors 104 can remove extraneous or duplicative data or create a summary of the data (e.g., latency, packets and bytes sent per traffic flow, flagging abnormal activity, etc.). According to some embodiments, sensors 104 are configured to selectively capture certain types of connection information while disregarding the rest. Further, as it can be overwhelming for a system to capture every packet, sensors can be configured to capture only a representative sample of packets (for example, every 1,000th packet). According to some embodiments, sensors 104 can generate aggregate network flow data that has been subjected to processing, rendering it light-weighted for subsequent transmitting and processing.

According to some embodiments, sensors 104 can perform various actions with regard to the associated network component. For example, a sensor installed on a VM can close, quarantine, restart, or throttle a process executing on the VM. Sensors 104 can create and enforce policies (e.g., block access to ports, protocols, or addresses). According to some embodiments, sensors 104 receive instructions to perform such actions; alternatively, sensors 104 can act autonomously without external direction.

Sensors 104 can send network flow data to one or more collectors 122. Sensors 104 can be assigned to send network flow data to a primary collector and a secondary collector. In some embodiments, sensors 104 are not assigned a collector, but determine an optimal collector through a discovery process. Sensors 104 can change a destination for the report if its environment changes. For example, if a certain collector experiences failure or if a sensor is migrated to a new location that is close to a different collector. According to some embodiments, sensors 104 send different network flow data to different collectors. For example, sensors 104 can send a first report related to one type of process to a first collector, and send a second report related to another type of process to a second collector.

Collectors 122 can be any type of storage medium that can serve as a repository for the data recorded by the sensors. According to some embodiments, collectors 122 are directly connected to the top of rack (TOR) switch; alternatively, collectors 122 can be located near the end of row or elsewhere on or off premises. The placement of collectors 122 can be optimized according to various priorities such as network capacity, cost, and system responsiveness. According to some embodiments, data storage of collectors 122 is located in an in-memory database such as dash DB by IBM. This approach benefits from rapid random access speeds that typically are required for analytics software. Alternatively, collectors 122 can utilize solid state drives, disk drives, magnetic tape drives, or a combination of the foregoing according to cost, responsiveness, and size requirements. Collectors 122 can utilize various database structures such as a normalized relational database or NoSQL database.

According to some embodiments, collectors 122 serve as network storage for application dependency mapping system 100. Additionally, collectors 122 can organize, summarize, and preprocess the collected data. For example, collectors 122 can tabulate how often packets of certain sizes or types are transmitted from different virtual machines. Collectors 122 can also characterize the traffic flows going to and from various network components. According to some embodiments, collectors 122 can match packets based on sequence numbers, thus identifying traffic flows as well as connection links.

According to some embodiments, collectors 122 flag anomalous data. Because it would be inefficient to retain all data indefinitely, collectors 122 can routinely replace detailed network flow data with consolidated summaries. In this manner, collectors 122 can retain a complete dataset describing one period (e.g., the past minute), with a smaller report of another period (e.g., the previous), and progressively consolidated network flow data of other times (day, week, month, year, etc.). By organizing, summarizing, and preprocessing the data, collectors 122 can help application dependency mapping system 100 scale efficiently. Although collectors 122 are generally herein referred to as a plural noun, a single machine or cluster of machines are contemplated to be sufficient, especially for smaller datacenters. In some embodiments, collectors 122 serve as sensors 104 as well.

According to some embodiments, in addition to data from sensors 104, collectors 122 can receive other types of data. For example, collectors 122 can receive out-of-band data 114 that includes, for example, geolocation data 116, IP watch lists 118, and WhoIs data 120. Additional out-of-band data can include power status, temperature data, etc.

Configuration/image manager 102 can configure and manage sensors 104. When a new virtual machine is instantiated or when an existing one is migrated, configuration and image manager 102 can provision and configure a new sensor on the machine. In some embodiments configuration and image manager 102 can monitor the health of sensors 104. For example, configuration and image manager 102 might request status updates or initiate tests. In some embodiments, configuration and image manager 102 also manages and provisions virtual machines.

Analytics module 124 can accomplish various tasks in its analysis, some of which are herein disclosed. By processing data stored in various collectors 122, analytics module 124 can automatically generate an application dependency map, which depicts the physical and logical dependencies of the application components, as well as the dependencies of the components on the underlying infrastructure resources. The application dependency map can identify, for example, communication paths between the nodes, the ports used for communication (e.g., TCP ports), as well as the processes executing on the nodes. This map can be instructive when analytics module 124 attempts to determine the root cause of a failure (because failure of one component can cascade and cause failure of its dependent components) or when analytics module 124 attempts to predict what will happen if a component is taken offline. Additionally, analytics module 124 can associate edges of an application dependency map with expected latency, bandwidth, etc. for that individual edge.

For example, if component A routinely sends data to component B, but component B never sends data to component A, then analytics module 124 can determine that component B is dependent on component A, but A is likely not dependent on component B. If, however, component B also sends data to component A, then they are likely interdependent. These components can be processes, virtual machines, hypervisors, VLANs, etc. Once analytics module 124 has determined component dependencies, it can then form an application dependency map that represents the application network topology.

Similarly, using data provided from sensors 104, analytics module 124 can determine relationships between interdependent applications, analytics module 124 can determine what type of devices exist on the network (brand and model of switches, gateways, machines, etc.), where they are physically located (e.g., latitude and longitude, building, datacenter, room, row, rack, machine, etc.), how they are interconnected (10 Gb Ethernet, fiber-optic, etc.), and what the strength of each connection is (bandwidth, latency, etc.). Automatically determining the network topology can facilitate integrating of application dependency mapping system 100 within an established datacenter. Furthermore, analytics module 124 can detect changes of network topology without the needed of further configuration.

Analytics module 124 can establish patterns and norms for component behavior. Analytics module 124 can determine that certain processes (when functioning normally) will only send a certain amount of traffic to a certain VM using a small set of ports. Analytics module 124 can establish these norms by analyzing individual components or by analyzing data coming from similar components (e.g., VMs with similar configurations). Similarly, analytics module 124 can determine expectations for network operations. For example, it can determine the expected latency between two components, the expected throughput of a component, response time of a component, typical packet sizes, traffic flow signatures, etc. In some embodiments, analytics module 124 can combine its dependency map with pattern analysis to create reaction expectations. For example, if traffic increases with one component, other components may predictably increase traffic in response (or latency, compute time, etc.).

According to some embodiments, analytics module 124 uses machine learning techniques to identify which patterns are policy-compliant or unwanted or harmful. For example, a network administrator can indicate network states corresponding to an attack and network states corresponding to normal operation. Analytics module 124 can then analyze the data to determine which patterns most correlate with the network being in a complaint or non-compliant state. According to some embodiments, the network can operate within a trusted environment for a time so that analytics module 124 can establish baseline normalcy. According to some embodiments, analytics module 124 contains a database of norms and expectations for various components. This database can incorporate data from sources external to the network. Analytics module 124 can then create network security policies for how components can interact. According to some embodiments, when policies are determined external to system 100, analytics module 124 can detect the policies and incorporate them into this framework. A network administrator can manually tweak the network security policies. For example, network security policies can be dynamically changed and be conditional on events. These policies can be enforced on the components. ADM policy engine 126 can maintain these network security policies and receive user input to change the policies.

ADM policy engine 126 can configure analytics module 124 to establish what network security policies exist or should be maintained. For example, ADM policy engine 126 may specify that certain machines should not intercommunicate or that certain ports are restricted. A network policy controller can set the parameters of ADM policy engine 126. According to some embodiments, ADM policy engine 126 is accessible via presentation module 128.

According to some embodiments, analytics module 124 can determine similarity scores for the nodes, which indicate similarity levels among the plurality of nodes. Presentation module 128 can display the similarity scores on a user interface. Further, the system can generate node clusters based on the similarity levels of the node, e.g. nodes sharing a high similarity score (e.g., higher than a selected threshold) are associated with one node cluster.

Presentation module 128 can comprise serving layer 129 and user interface (UI) 130 that is operable to display, for example, information related to the application dependency map. As analytics module 124 analyzes the aggregate network flow data, they may not be in a human-readable form or they may be too large for an administrator to navigate. Presentation module 128 can take the network flow data generated by analytics module 124 and further summarize, filter, and organize the network flow data as well as create intuitive presentations of the network flow data.

Serving layer 129 can be the interface between presentation module 128 and analytics module 124. As analytics module 124 generates node attributes, serving layer 129 can summarize, filter, and organize the attributes that comes from analytics module 124. According to some embodiments, serving layer 129 can request raw data from a sensor, collector, or analytics module 124.

UI 130 can connect with serving layer 129 to present the data in a page for human presentation. For example, UI 130 can present the data in bar charts, core charts, tree maps, acyclic dependency maps, line graphs, tables, etc. UI 130 can be configured to allow a user to “drill down” on information sets to get a filtered data representation specific to the item the user wishes to “drill down” to. For example, individual traffic flows, components, etc. UI 130 can also be configured to allow a user to filter by search. This search filter can use natural language processing to determine analyze the network administrator's input. There can be options to view data relative to the current second, minute, hour, day, etc. UI 130 can allow a network administrator to view traffic flows, application dependency maps, network topology, etc.

According to some embodiments, UI 130 can receive inputs from a network administrator to adjust configurations in application dependency mapping system 100 or components of the datacenter. These instructions can be passed through serving layer 129, sent to configuration/image manager 102, or sent to analytics module 124.

After receiving an adjustment to an input parameter, analytics module 124 can generated an updated application dependency map using the adjusted parameters. For example, the user can remove or add a node from a selected node cluster and rerun the node clustering, or an application dependency mapping (ADM) pipeline. The user can define a period of time for generating the updated application dependency map, for example, Aug. 1, 2012-Aug. 14, 2012. The user can also create/name a new workspace, select nodes for generating the updated map, and upload side information, e.g., routs/subnets, load balancer information, for generating the map. Additionally, the user can, while adjusting part of the cluster parameters, approve or preserver certain cluster so that they are not subjected to re-runs.

Further, the user can adjust the clustering granularity, for example, via a knob or a selectable element on UI 130. The clustering granularity can generated a preferred number of node clusters. For example, a coarse-grained system with a low granularity comprises fewer clusters of nodes, whereas a fine-grained system with a higher granularity comprises more clusters of nodes.

With the updated application dependency mapping completed, the user can view network information on UI 130. For example, such information includes statistics of the network, number/name of the node clusters, port information related to nodes, comparison summary between the last ADM to the recent ADM.

Additionally, the various elements of application dependency mapping system 100 can exist in various configurations. For example, collectors 122 can be a component of sensors 104. In some embodiments, additional elements can share certain portion of computation to ease the load of analytics module 124.

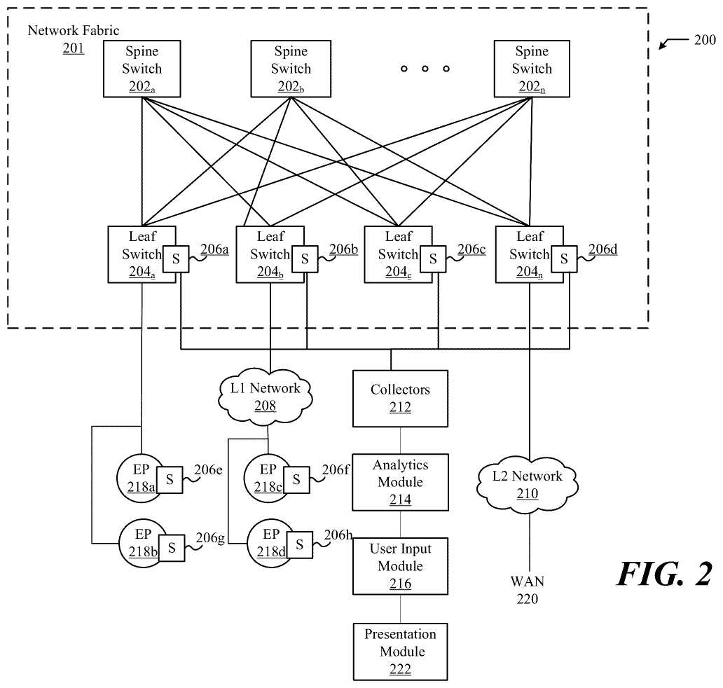

FIG. 2 illustrates an example of an application dependency mapping system 200 adopting a leaf-spine architecture, according to some embodiments. Network fabric 201 can include spine switches 202ₐ, 202_{b}, . . . , 202ₙ (collectively, “202”) connected to leaf switches 204ₐ, 204_{b}, 204_{c}, . . . , 204ₙ (collectively “204”). Leaf switches 204 can include access ports (or non-fabric ports) and fabric ports. Fabric ports can provide uplinks to the spine switches 202, while access ports can provide connectivity for devices, hosts, end points, VMs, or external networks to network fabric 201. Although a leaf-spine architecture is illustrated in network fabric 201, one of ordinary skill in the art will readily recognize that the subject technology can be implemented based on any network fabric, including any data center or cloud network fabric. Indeed, other architectures, designs, infrastructures, and variations are contemplated herein.

Spine switches 202 can support various capabilities, such as 40 or 10 Gbps Ethernet speeds. Spine switches 202 can include one or more 40 Gigabit Ethernet ports, each of which can also be split to support other speeds. For example, a 40 Gigabit Ethernet port can be split into four 10 Gigabit Ethernet ports.

Leaf switches 204 can reside at the edge of network fabric 201, thus representing the physical network edge. According to some embodiments, the leaf switches 204 can be top-of-rack switches configured according to a top-of-rack architecture. According to some embodiments, the leaf switches 204 can be aggregation switches in any particular topology, such as end-of-row or middle-of-row topologies. The leaf switches 204 can also represent aggregation switches.

Leaf switches 204 can be responsible for routing and/or bridging the tenant packets and applying network policies. According to some embodiments, a leaf switch can perform one or more additional functions, such as implementing a mapping cache, sending packets to the proxy function when there is a miss in the cache, encapsulate packets, enforce ingress or egress policies, etc.

Network connectivity in network fabric 201 can flow through the leaf switches 204. For example, leaf switches 204 can provide servers, resources, endpoints, external networks, or VMs network access to network fabric 201. According to some embodiments, leaf switches 204 can connect one or more end point groups to network fabric 201 or any external networks. Each end point group can connect to network fabric 201 via one of leaf switches 204.

Endpoints 218ₐ-218_{d} (collectively “218”) can connect to network fabric 201 via leaf switches 204. For example, endpoints 218ₐ and 218_{b} can connect directly to leaf switch 204A. On the other hand, endpoints 218_{c} and 218_{d} can connect to leaf switch 204_{b} via L1 network 208. Similarly, wide area network (WAN) 220 can connect to leaf switches 204ₙ via L2 network 210.

Endpoints 218 can include any communication device or component, such as a node, computer, server, blade, hypervisor, virtual machine, container, process (e.g., running on a virtual machine), switch, router, gateway, etc. According to some embodiments, endpoints 218 can include a server, hypervisor, process, or switch configured with a VTEP functionality which connects an overlay network with network fabric 201. The overlay network can host physical devices, such as servers, applications, EPGs, virtual segments, virtual workloads, etc. In addition, endpoints 218 can host virtual workload(s), clusters, and applications or services, which can connect with network fabric 201 or any other device or network, including an external network. For example, one or more endpoints 218 can host, or connect to, a cluster of load balancers or an end point group of various applications.

Sensors 206ₐ-206ₕ (collectively “206) can be associated with each node and component of a data center (e.g., virtual machine, hypervisor, slice, blade, switch, router, gateway, etc.). As illustrated in FIG. 2, sensors 206 can be respectively associated with leaf switches 204 and endpoints 218. Sensors 206 can monitor communications to and from the component, report on environmental data related to the component (e.g., component IDs, statuses, etc.), and perform actions related to the component (e.g., shut down a process, block ports, redirect traffic, etc.). Sensors 206 can send these data to the collectors 212 for storage.

Sensors 206 can preprocess network flow data before sending. For example, sensors 206 can remove extraneous or duplicative data or create a summary of the data (e.g., latency, packets and bytes sent per traffic flow, flagging abnormal activity, etc.). According to some embodiments, sensors 206 are configured to selectively capture certain types of connection information while disregarding the rest. Further, as it can be overwhelming for a system to capture every packet, sensors can be configured to capture only a representative sample of packets (for example, every 1,000th packet).

According to some embodiments, sensors 206 can perform various actions with regard to the associated network component. For example, a sensor installed on a VM can close, quarantine, restart, or throttle a process executing on the VM. Sensors 206 can create and enforce security policies (e.g., block access to ports, protocols, or addresses). According to some embodiments, sensors 206 receive instructions to perform such actions; alternatively, sensors 104 can act autonomously without external direction.

Sensors 206 can send network flow data to one or more collectors 212. Sensors 206 can be assigned to send network flow data to a primary collector and a secondary collector. In some embodiments, sensors 206 are not assigned a collector, but determine an optimal collector through a discovery process. Sensors 206 can change a destination for the report if its environment changes. For example, if a certain collector experiences failure or if a sensor is migrated to a new location that is close to a different collector. According to some embodiments, sensors 206 send different network flow data to different collectors. For example, sensors 206 can send a first report related to one type of process to a first collector, and send a second report related to another type of process to a second collector.

Collectors 212 can be any type of storage medium that can serve as a repository for the data recorded by the sensors. Collectors 212 can be connected to network fabric 201 via one or more network interfaces. Collectors 212 can be located near the end of row or elsewhere on or off premises. The placement of collectors 212 can be optimized according to various priorities such as network capacity, cost, and system responsiveness. Although collectors 122 are generally herein referred to as a plural noun, a single machine or cluster of machines are contemplated to be sufficient, especially for smaller datacenters. In some embodiments, collectors 122 serve as sensors 202 as well.

According to some embodiments, collectors 212 serve as network storage for network flow data. Additionally, collectors 212 can organize, summarize, and preprocess the collected data. For example, collectors 212 can tabulate how often packets of certain sizes or types are transmitted from different virtual machines. Collectors 212 can also characterize the traffic flows going to and from various network components. According to some embodiments, collectors 212 can match packets based on sequence numbers, thus identifying traffic flows as well as connection links.

Analytics module 214 can automatically generate an application dependency map, which depicts the physical and logical dependencies of the application components, as well as the dependencies of the components on the underlying infrastructure resources. The application dependency map can identify, for example, communication paths between the nodes, the ports used for communication, as well as the processes executing on the nodes. This map can be instructive when analytics module 214 attempts to determine the root cause of a failure (because failure of one component can cascade and cause failure of its dependent components) or when analytics module 214 attempts to predict what will happen if a component is taken offline. Additionally, analytics module 214 can associate edges of an application dependency map with expected latency, bandwidth, etc. for that individual edge.

Similarly, using data provided from sensors 206, analytics module 214 can determine relationships between interdependent applications, analytics module 214 can determine what type of devices exist on the network (brand and model of switches, gateways, machines, etc.), where they are physically located (e.g., latitude and longitude, building, datacenter, room, row, rack, machine, etc.), how they are interconnected (10 Gb Ethernet, fiber-optic, etc.), and what the strength of each connection is (bandwidth, latency, etc.). Automatically determining the network topology can facilitate integrating of application dependency mapping system 200 within an established datacenter. Furthermore, analytics module 214 can detect changes of network topology without the needed of further configuration.

According to some embodiments, analytics module 214 can determine similarity scores for the nodes, which indicate similarity levels among the plurality of nodes. Presentation module 222 can display the similarity scores on a user interface. Further, the system can generate node clusters based on the similarity levels of the node, e.g. nodes sharing a high similarity score (e.g., higher than a selected threshold) are associated with one node cluster.

According to some embodiments, the application dependency mapping system can enable re-runs of application dependent mapping to implement various adjustments to the system. For example, a system administrator can make one or more adjustments, e.g. editing the size of the clusters, changing data-capturing time, to optimize the system performance. Analytics module 214 can compare the re-run data with the original data to summarize the recent adjustments, e.g. by matching the clusters with a matching algorithm. Additionally, presentation module 222 can display the summary of the changes on a user interface. This feature can help the administrator or user to track the implemented changes, make necessary adjustments, and improve system performance.

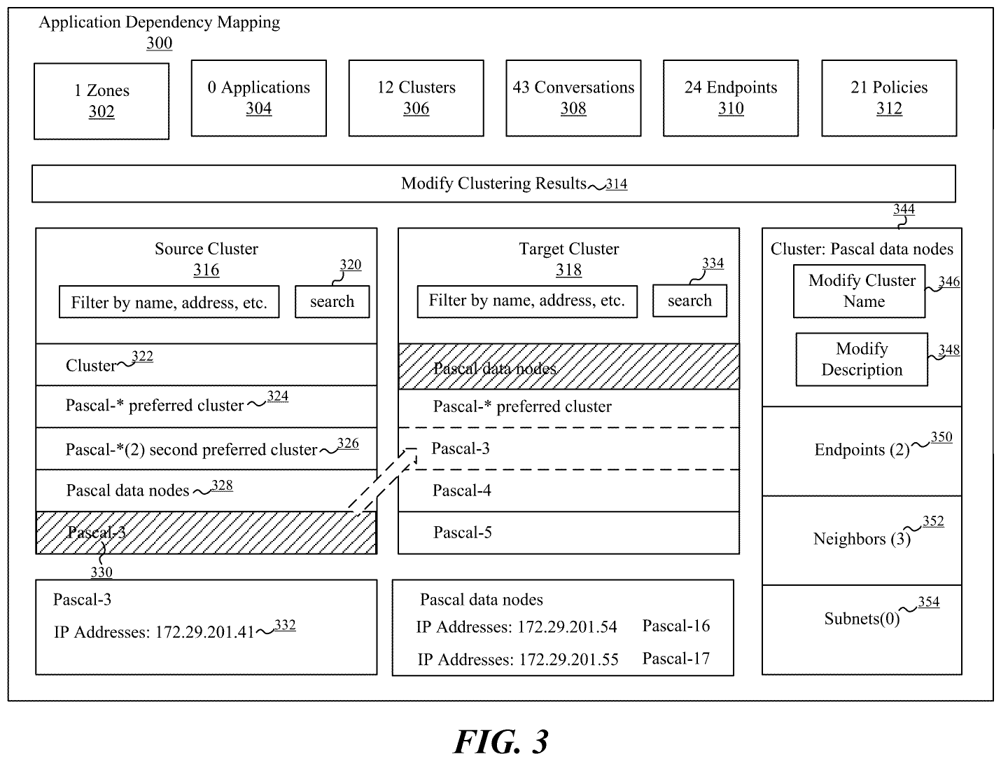

FIG. 3 illustrates an example of a user interface of an application dependency mapping system, according to some embodiments. It should be appreciated that the user interface in FIG. 3 is an example, and any other information sections may be included in FIG. 3.

Application dependent mapping 300 illustrates 1 zone 302 that include a number of nodes with 0 applications (304) executing on them. These nodes are divided to 12 clusters (306) having 43 conversations (308). There are 24 endpoints (310) having 21 policies (312).

As shown in FIG. 3, a network administrator or user can modify network input parameters via a selectable element such as modify clustering results 314. For example, source cluster 316 can include a number of nodes such as cluster 322, Pascal-* preferred cluster 324, Pascal-*(2) second preferred cluster 326, Pascal-data node 328, and Pacal-3 330. Target cluster 318 can originally include Pascal-4, Pascal-5. The user, after reviewing the automatically generated clustering nodes, can manually adjust the clustering, by removing or adding selected nodes to a cluster. For example, the user can move Pascal-* preferred cluster 324, Pascal-data node 328, and pascal-3 330 from source cluster 316 to target cluster 318.

As shown in FIG. 3, by selecting a specific node, the user can view detailed information related to it. In this example, the user selects to view Pascal-3 330, which is associated with IP Addresses: 172.29.201.41 (332). Similarly, Pascal-data node 328, which includes Pascal-16 and Pacal-17, is respectively associated with IP Addresses: 172.29.201.54 and IP Addresses: 172.29.201.55.

Source cluster 326 can include a search tab 320 to allow an administrator to “drill down” on information sets to get a filtered data representation. This search filter can use natural language processing to determine analyze the administrator's input. There can be options to view data relative to the current second, minute, hour, day, etc. Similarly, target cluster 318 can include a search tab 334 to perform similar functions.

When selecting Pascal data nodes 328, the user can modify network parameters related to this node cluster. For example, the user can modify the cluster's name via selecting modify cluster name tab 346, which enables the user to change the cluster name. The user can also modify node cluster description via selecting modify description tab 348, e.g. to define selected nodes for executing processes. Further, the user can edit parameters related to endpoints (2) 350 neighbors (3) 352 and subnets (0) 354.

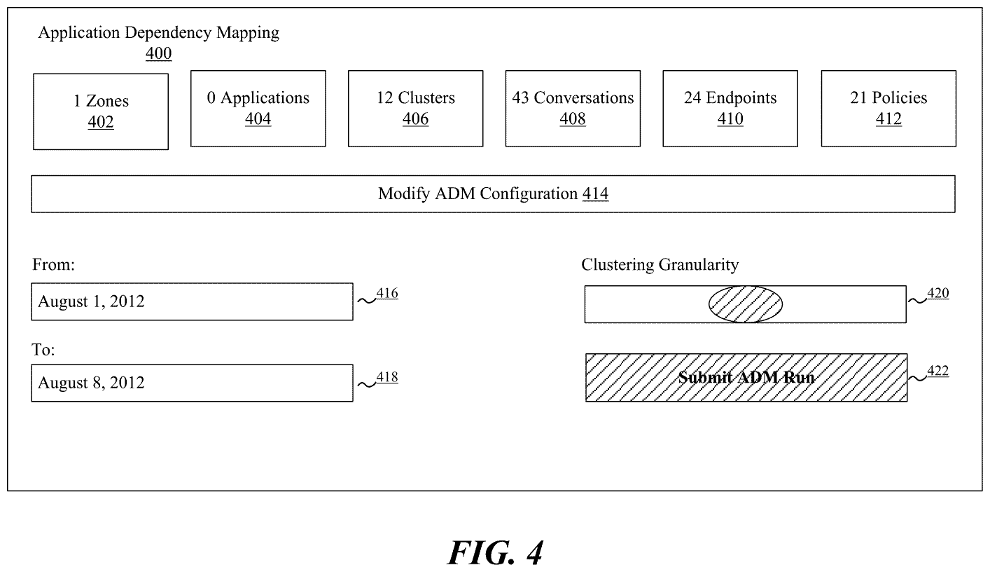

FIG. 4 illustrates an example of another user interface of an application dependency mapping system, according to some embodiments. Application dependent mapping 400 illustrates 1 zone (402) that include a number of nodes with 0 applications (404) executing on them. These nodes are divided to 12 clusters (406) having 43 conversations (408). There are 24 endpoints (410) having 21 policies (412). The modify ADM configuration tab 414 enables the user to modify network parameters.

The user can define a period of time for generating the updated application dependency map, for example, from a first time 416 to a second time 418 (e.g., Aug. 1, 2012-Aug. 8, 2012). The user can adjust the clustering granularity, for example, via a knob 420 or a selectable element, which can generate a preferred number of node clusters. For example, a coarse-grained system with a low granularity comprises fewer clusters of nodes, whereas a fine-grained system with a higher granularity comprises more clusters of nodes. Additionally, the user can also create/name a new workspace, select nodes for generating the updated map, and upload side information, e.g., routs/subnets, load balancer information, for generating the map. The user can, while adjusting part of the cluster parameters, approve or preserver certain cluster so that they are not subjected to re-runs.

After completing the adjustments, the user can select submit ADM run tab 422 for implementing the adjustments. With the ADM rerun completed, the user can view information including statistics of the network, number/name of the node clusters, port information related to nodes, comparison summary between the last ADM to the recent ADM. For example, to compare two ADMs, cluster statistics can be calculated to show 1) the number of clusters that is added, 2) the number of clusters that is removed, 3) the number of existing clusters that are modified, and 4) the number of clusters remain unchanged, etc.

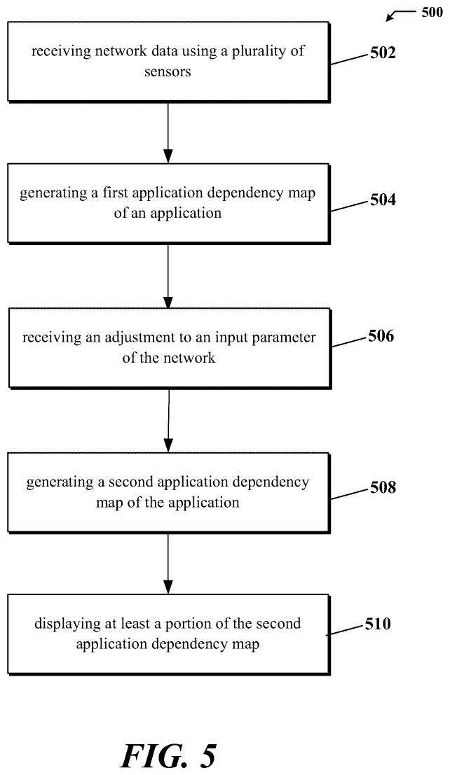

FIG. 5 is a flow diagram illustrating an example of a process for an application dependency mapping system, according to some embodiments. It should be understood that there can be additional, fewer, or alternative steps performed in similar or alternative orders, or in parallel, within the scope of the various embodiments unless otherwise stated.

At step 502, an application dependency mapping system can receive receiving network data using a plurality of sensors associated with a plurality of nodes of a network. The plurality of sensors includes at least a first sensor of a physical switch of the network, a second sensor of a hypervisor associated with the physical switch, a third sensor of a virtual machine associated with the hypervisor. For example, as illustrated in FIG. 2, Sensors 206 can be associated with various nodes and components of a data center (e.g., virtual machine, hypervisor, slice, blade, switch, router, gateway, etc.). Sensors 206 can be respectively associated leaf switches, hypervisors, and virtual machines. Sensors 206 can monitor communications to and from the component, report on environmental data related to the component (e.g., component IDs, statuses, etc.), and perform actions related to the component (e.g., shut down a process, block ports, redirect traffic, etc.). As illustrated in FIG. 2, the system 200 can receive data packets sent from the first endpoint group associated with EP 218ₐ and destined for the second endpoint group associated with EP 218_{d}.

At step 504, the application dependency mapping system can generate, based at least in part on the network data, a first application dependency map of an application executing in the network, the first dependency map representing an application network topology. For example, by analyzing aggregate network flow data, analytics module 214 can automatically generate an application dependency map, which can identify, for example, communication paths between the nodes, the ports used for communication, as well as the processes executing on the nodes. This map can be instructive when analytics module 214 attempts to determine the root cause of a failure (because failure of one component can cascade and cause failure of its dependent components) or when analytics module 214 attempts to predict what will happen if a component is taken offline. Additionally, analytics module 214 can associate edges of an application dependency map with expected latency, bandwidth, etc. for that individual edge.

According to some embodiments, analytics module 214 can determine similarity scores for the nodes, which indicate similarity levels among the plurality of nodes. Further, the system can generate node clusters based on the similarity levels of the node, e.g. nodes sharing a high similarity score (e.g., higher than a selected threshold) are associated with one node cluster.

Analytics module 214 can create network security policies for how components can interact. A network administrator can manually tweak the network security policies. For example, network security policies can be dynamically changed and be conditional on events. These policies can be enforced on the components. ADM policy engine can maintain these network security policies and receive user input to change the policies.

At step 506, the application dependency mapping system can receive, via a user interface, an adjustment to an input parameter of the network. For example, the user can remove or add a node from a selected node cluster and rerun the node clustering, or an application dependency mapping pipeline. The user can define a period of time for generating the updated application dependency map. The user can also create/name a new workspace, select nodes for generating the updated map, and upload side information, e.g., routs/subnets, load balancer information, for generating the map. The user can also approve or preserve certain cluster so that they are not subjected to re-runs and consume system resources. For example, the system can receive a user approval for a clustering of nodes and prevent changes to the cluster of nodes in terms of node membership statuses.

At step 508, the application dependency mapping system can generate a second application dependency map of the application, the second dependency map representing an updated network topology. According to some embodiments, the application dependency mapping system can enable re-runs or revision of an application dependent mapping to implement various adjustments to the system.

At step 510, the application dependency mapping system can display at least a portion of the second application dependency map. For example, with the ADM rerun completed, the user can view information including statistics of the network, number/name of the node clusters, port information related to nodes, comparison summary between the last ADM to the recent ADM. Cluster statistics can include 1) the number of clusters that is added, 2) the number of clusters that is removed, 3) the number of existing clusters that are modified, and 4) the number of clusters remain unchanged, etc.

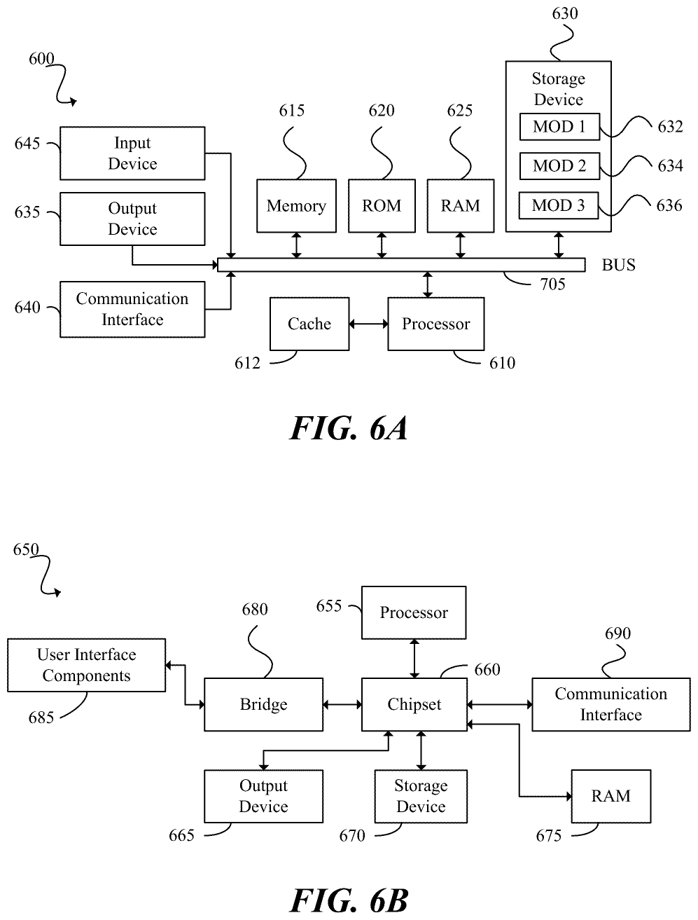

FIGS. 6A and 6B illustrate a computing platform of a computing device, according to some embodiments. FIG. 6A and FIG. 6B illustrate example system embodiments. The more appropriate embodiment will be apparent to those of ordinary skill in the art when practicing the present technology. Persons of ordinary skill in the art will also readily appreciate that other system embodiments are possible.

FIG. 6A illustrates a conventional system bus computing system architecture 600 wherein the components of the system are in electrical communication with each other using a bus 605. Example system 600 includes a processing unit (CPU or processor) 610 and a system bus 605 that couples various system components including the system memory 615, such as read only memory (ROM) 620 and random access memory (RAM) 625, to the processor 610. The system 600 can include a cache of high-speed memory connected directly with, in close proximity to, or integrated as part of the processor 610. The system 600 can copy data from the memory 615 and/or the storage device 630 to the cache 612 for quick access by the processor 610. In this way, the cache can provide a performance boost that avoids processor 610 delays while waiting for data. These and other modules can control or be configured to control the processor 610 to perform various actions. Other system memory 615 may be available for use as well. The memory 615 can include multiple different types of memory with different performance characteristics. The processor 610 can include any general purpose processor and a hardware module or software module, such as module 1 632, module 2 634, and module 3 636 stored in storage device 630, configured to control the processor 610 as well as a special-purpose processor where software instructions are incorporated into the actual processor design. The processor 610 may essentially be a completely self-contained computing system, containing multiple cores or processors, a bus, memory controller, cache, etc. A multi-core processor may be symmetric or asymmetric.

To enable user interaction with the computing device 600, an input device 645 can represent any number of input mechanisms, such as a microphone for speech, a touch-sensitive screen for gesture or graphical input, keyboard, mouse, motion input, speech and so forth. An output device 635 can also be one or more of a number of output mechanisms known to those of skill in the art. In some instances, multimodal systems can enable a user to provide multiple types of input to communicate with the computing device 600. The communications interface 640 can generally govern and manage the user input and system output. There is no restriction on operating on any particular hardware arrangement and therefore the basic features here may easily be substituted for improved hardware or firmware arrangements as they are developed.

Storage device 630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 625, read only memory (ROM) 620, and hybrids thereof.

The storage device 630 can include software modules 632, 634, 636 for controlling the processor 610. Other hardware or software modules are contemplated. The storage device 630 can be connected to the system bus 605. In one aspect, a hardware module that performs a particular function can include the software component stored in a computer-readable medium in connection with the necessary hardware components, such as the processor 610, bus 605, output device 635, and so forth, to carry out the function.

FIG. 6B illustrates an example computer system 650 having a chipset architecture that can be used in executing the described method and generating and displaying a graphical user interface (GUI). Computer system 650 is an example of computer hardware, software, and firmware that can be used to implement the disclosed technology. System 650 can include a processor 655, representative of any number of physically and/or logically distinct resources capable of executing software, firmware, and hardware configured to perform identified computations. Processor 655 can communicate with a chipset 660 that can control input to and output from processor 655. In this example, chipset 660 outputs information to output 665, such as a display, and can read and write information to storage device 670, which can include magnetic media, and solid state media, for example. Chipset 660 can also read data from and write data to RAM 675. A bridge 680 for interfacing with a variety of user interface components 685 can be provided for interfacing with chipset 660. Such user interface components 685 can include a keyboard, a microphone, touch detection and processing circuitry, a pointing device, such as a mouse, and so on. In general, inputs to system 650 can come from any of a variety of sources, machine generated and/or human generated.

Chipset 660 can also interface with one or more communication interfaces 690 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 655 analyzing data stored in storage 670 or 675. Further, the machine can receive inputs from a user via user interface components 685 and execute appropriate functions, such as browsing functions by interpreting these inputs using processor 655.

It can be appreciated that example systems 600 and 650 can have more than one processor 610 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Moreover, claim language reciting “at least one of” a set indicates that one member of the set or multiple members of the set satisfy the claim.

1. A method, comprising:
receiving network data associated with a plurality of nodes of a network;
generating, based at least in part on the network data, a first application dependency map of an application executing in the network, the first application dependency map representing an application network topology;
receiving, via a user interface, an adjustment to an input parameter of the network, wherein the adjustment is a change to at least one node of the plurality of nodes of the network;
generating a second application dependency map of the application based on the adjustment, the second application dependency map representing an update to the application network topology; and
displaying at least a portion of the second application dependency map.

2. The method of claim 1, wherein the plurality of nodes are associated with plurality of sensors for collecting the network data.

3. The method of claim 2, wherein the plurality of sensors include at least a first sensor of a physical switch of the network, a second sensor of a hypervisor associated with the physical switch, a third sensor of a virtual machine associated with the hypervisor.

4. The method of claim 1, wherein the first and second application dependency maps, each identify communication paths between nodes of the plurality of nodes of the network, ports used for communication, or processes executing on the plurality of nodes.

5. The method of claim 4, wherein the change to the at least one node of the plurality of nodes includes either removing or adding a node from a node cluster.

6. The method of claim 1, wherein the second application dependency map is generated based on a user-defined period of time.

7. The method of claim 1, wherein the adjustment to the input parameter includes changing a clustering granularity for generating the second application dependency map from at least a portion of the plurality of nodes.

8. The method of claim 1, further comprising:
receiving user approval of one or more node membership statuses; and
preventing a change to the one or more node membership statuses while the second application dependency map is generated.

9. The method of claim 1, further comprising:
accessing user-uploaded side information for generating the second application dependency map; and
generating the second application dependency map based on the side information.

10. A system comprising:
one or more processors; and
a computer-readable medium comprising instructions stored therein, which when executed by the one or more processors, cause the system to:
receive network data associated with a plurality of nodes of a network;
generate, based at least in part on the network data, a first application dependency map of an application executing in the network, the first application dependency map representing an application network topology;
receive, via a user interface, an adjustment to an input parameter of the network, wherein the adjustment is a change to at least one node of the plurality of nodes of the network;
generate a second application dependency map of the application based on the adjustment, the second application dependency map representing an update to the application network topology; and
display at least a portion of the second application dependency map.

11. The system of claim 10, wherein the plurality of nodes are associated with plurality of sensors for collecting the network data.

12. The system of claim 11, wherein the plurality of sensors include at least a first sensor of a physical switch of the network, a second sensor of a hypervisor associated with the physical switch, a third sensor of a virtual machine associated with the hypervisor.

13. The system of claim 10, wherein the first and second application dependency maps, each identify communication paths between nodes of the plurality of nodes of the network, ports used for communication, or processes executing on the plurality of nodes.

14. The system of claim 13, wherein the change to the at least one node of the plurality of nodes includes either removing or adding a node from a node cluster.

15. The system of claim 10, wherein the second application dependency map is generated based on a user-defined period of time.

16. The system of claim 10, wherein the adjustment to the input parameter includes changing a clustering granularity for generating the second application dependency map from at least a portion of the plurality of nodes.

17. The system of claim 10, further comprising instructions which when executed cause the system to:
receiving user approval of one or more node membership statuses; and
preventing a change to the one or more node membership statuses while the second application dependency map is generated.

18. The system of claim 10, further comprising instructions which when executed cause the system to:
accessing user-uploaded side information for generating the second application dependency map; and
generating the second application dependency map based on the side information.

19. A non-transitory computer-readable storage medium comprising instructions stored therein, which when executed by one or more processors, cause the one or more processors to:
receive network data associated with a plurality of nodes of a network;
generate, based at least in part on the network data, a first application dependency map of an application executing in the network, the first application dependency map representing an application network topology;
receive, via a user interface, an adjustment to an input parameter of the network, wherein the adjustment is a change to at least one node of the plurality of nodes of the network;
generate a second application dependency map of the application based on the adjustment, the second application dependency map representing an update to the application network topology; and
display at least a portion of the second application dependency map.

20. The non-transitory computer-readable storage medium of claim 19, wherein the change to the at least one node of the plurality of nodes includes either removing or adding a node from a node cluster.
